(19) United States
(12) Patent Application Publication
(10) Pub. No.: US 2020/0039644 A1
(43) Pub. Date: Feb. 6, 2020

(54) Droneboarding Tow Bar With Integrated Flight Controller

(71) Applicant: David Edward Henry, Kailua, HI (US)

(72) Inventor: David Edward Henry, Kailua, HI (US)

(21) Appl. No.: 16/051,157

(22) Filed: Jul. 31, 2018

(51) Int. Cl. B64C 39/02; G08G 5/00

(52) U.S. Cl. CPC B64C 39/024; B64C 2201/12; G08G 5/0069

(57) ABSTRACT

A tow bar assembly for use in a droneboarding system is disclosed. The tow bar assembly includes a shaft adapted to be connected to an unmanned aerial vehicle via at least one tension line. A multi-axis interface device is associated with the shaft and is adapted to receive flight control commands from a user holding onto the shaft. A flight controller is mounted to the shaft and is adapted to generate flight control signals for controlling the flight path of the unmanned aerial vehicle according to the flight control commands received from the user via the multi-axis interface device. The flight controller is further adapted to wirelessly transmit the flight control signals to the unmanned aerial vehicle.

### BACKGROUND

Droneboarding is a relatively new form of recreational activity. Droneboarding is similar to the more established sport of kitesurfing, or kiteboarding. In kiteboarding, kiteboarders employ a large kite or sail to pull themselves over some surface, such as the surface of a lake or the ocean or, in colder climes, a snow-covered field. A kiteboarder typically rides a board adapted for the particular surface over which he or she intends to travel. For example, a kiteboarder kiteboarding on the ocean or on a lake may ride a surfboard, a wakeboard, a water ski, or the like; whereas a kiteboarder kiteboarding in the snow may ride a snowboard or skis. Urban and suburban kiteboarders may ride a skateboard or the like. Alternatively, kiteboarders may dispense with a board altogether in favor of ice skates, roller skates, a bike, or some other wheeled vehicle.

A limitation of kiteboarding is that it is dependent on the wind. On calm days the avid kiteboarder must be content with other activities. Not only is kiteboarding dependent on the strength of the wind, but on the direction of the wind as well. For example, a strong wind blowing onto shore can prevent ocean bound kiteboarders from ever getting out onto the water. As any sailor knows, the wind can be a powerful, yet fickle power source for propelling your craft.

Droneboarding solves this problem by replacing the kite with an unmanned aerial vehicle, or “drone.” Whereas many people are familiar with relatively small drones, such as those supporting airborne video cameras or those that have been proposed for delivering packages, larger more powerful drones have been developed capable of pulling individuals over water, snow and other surfaces at exciting speeds. Employing a drone as the motive force in a droneboarding system greatly increases the opportunities and locations where one may enjoy the sport of “boarding” as compared to the opportunities and locations available when a kite is employed.

While solving some of the issues inherent in kiteboarding, droneboarding is itself not without challenges. A significant challenge with droneboarding is determining how to control the flight path of the unmanned aerial vehicle. In typical droneboarding systems the individual being pulled by the drone has little or no control over the flight path of the drone. A companion is necessary to remotely pilot the craft. The remote pilot sends direction and speed commands to the drone via radio control signals. With this arrangement, the droneboarder, pulled along behind the drone, is simply along for the ride. Unfortunately, it is not always possible for a droneboarder to find a friend who is available to pilot his or her drone. In such cases, the droneboarder must look to other activities to fill his or her time.

For the sport of droneboarding to grow and thrive, a solution to this challenge is required. Droneboarding enthusiasts see a need for new mechanisms and methods for controlling the flight path of a drone. Preferably such new mechanisms and methods will allow the individual being pulled by the drone to directly control the direction in which the drone is flying.

### SUMMARY OF THE INVENTION

The present invention relates to a droneboarding system in which a droneboarder who is being pulled along by an unmanned aerial vehicle may remotely control the flight path of the unmanned aerial vehicle. According to an embodiment of the invention a droneboarding system includes an unmanned aerial vehicle, a tow bar and a tension line connected between the unmanned aerial vehicle and the tow bar. An input device associated with the tow bar is provided for receiving flight control commands from the droneboarder while the droneboarder is being pulled along by the unmanned aerial vehicle. A flight controller is mounted within the tow bar and is adapted to generate flight control signals corresponding to the flight commands received by the input device. The flight controller is further adapted to wirelessly transmit the flight control signals to the unmanned aerial vehicle to control the vehicle's flight path.

According to another aspect of the invention, a tow bar assembly adapted to be connected to an unmanned aerial vehicle via one or more tension lines for pulling a droneboarder is provided. The tow bar according to this aspect of the invention has the form of a substantially cylindrical, hollow shaft. Left and right tension line attachment structures are located near the left and right ends of the shaft for securing left and right tension lines or left and right lateral stabilizing lines to the shaft. A first multi-axis interface is mounted to the shaft in a manner accessible by a droneboarder gripping the shaft. The first multi-axis interface allows the droneboarder to conveniently enter flight control commands for controlling the flight path of the unmanned aerial vehicle as the droneboarder is being pulled along by the unmanned aerial vehicle by way the attached tow bar. Electronic circuitry is housed within the hollow shaft for interpreting the flight control commands received by the multi-axis input device and generating flight control signals according to the received flight control commands. The electronic circuitry further includes a transmitter for wirelessly communicating the flight control signals to the unmanned aerial vehicle.

Finally, a remote-control radio interface device is provided for controlling the flight path of an unmanned aerial vehicle. The remote-control radio interface includes a first multi-axis input device adapted to receive user input flight commands. A first multi-channel radio controller is provided for generating and transmitting a plurality of flight control signals to an unmanned aerial vehicle. The flight control signals correspond to the user input commands received by the first multi-axis input device. The remote-control radio interface device includes a first handle oriented such that a user, gripping the handle with one of his or her hands, may manipulate the first multi-axis input device with the thumb of that hand. A tension line securing structure is provided for securing a tension line or a lateral stabilizing line to the remote-control radio interface device. The opposite end of such a tension line may be attached to an unmanned aerial vehicle, so that the unmanned aerial vehicle may pull the remote radio interface device forward in the direction the unmanned aerial vehicle is traveling, along with the droneboarder gripping the handle.

### BRIEF DESCRIPTION OF THE DRAWINGS

FIG. 1 is a three-dimensional representation of a droneboarding tow bar according to an embodiment of the invention;

FIG. 2 is a three-dimensional representation of an end cap adapted to enclose the ends of the tow bars depicted in FIGS. 1, 3 and 6;

FIG. 3 is a three-dimensional representation of a droneboarding tow bar according to an alternative embodiment of the invention;

FIG. 4 is a three-dimensional representation of a carrier for supporting a flight controller within a tow bar according the to present invention;

FIG. 5 is a three-dimensional representation of a flight controller for controlling the flight path of an unmanned aerial vehicle;

FIG. 6 is a three-dimensional representation of a tow bar and associated hardware for a drone boarding system according to an alternative embodiment of the present invention;

FIG. 7 is a three-dimensional representation of a droneboarder employing a droneboarding system according to the present invention;

FIG. 8 is a three-dimensional representation of a droneboarding tow bar according to an alternative embodiment of the invention;

FIG. 9 is a three-dimensional representation of a droneboarding tow bar according to yet another alternative embodiment of the invention.

### DETAILED DESCRIPTION OF THE PREFERRED EMBODIMENTS

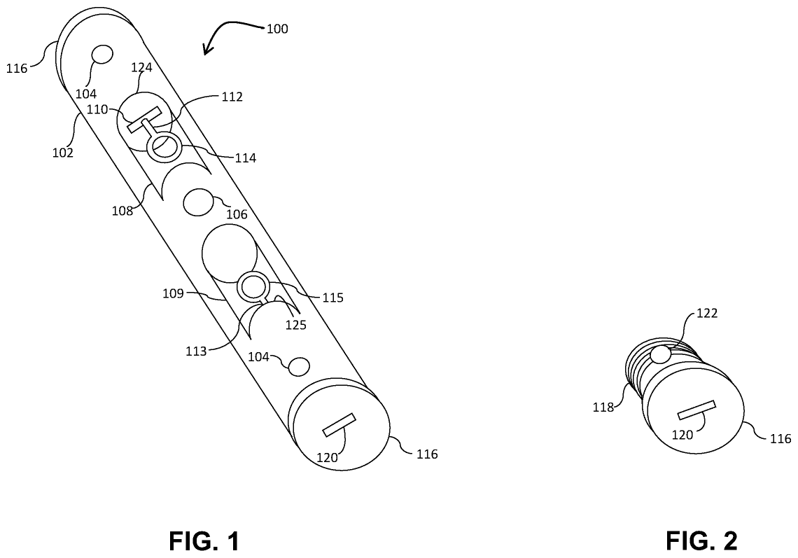

Turning first to FIGS. 1 and 2, a first embodiment of a droneboarding tow bar 100 is shown. The tow bar 100 is formed of a rigid hollow shaft 102. A pair of diametrically opposed holes 104 are formed through each end of the shaft 102. A similar pair of diametrically opposed holes 106 are formed through the center of the shaft 102.

Threaded end caps 116 are provided for each end of the hollow shaft 102. Threads 118 formed on an outer surface of the end caps 116 are adapted to rotatably engage mating threads (not shown) formed on an inner surface of each end of the hollow shaft 102 to enclose and seal the ends of the hollow shaft 102. A slot 120 may be formed on the outer surface of each end cap 116. The slot 120 may be adapted to receive a flathead screw driver, a coin, or the like for tightening the end caps 116 onto the ends of the shaft 102. Alternatively, the slot 120 could be replaced with a cruciform indentation for receiving a Phillips head screw driver, a hexagonal indentation for receiving an Allen wrench, or some other structure for receiving or engaging a tool for tightening the end caps 116 onto the ends of the shaft 102.

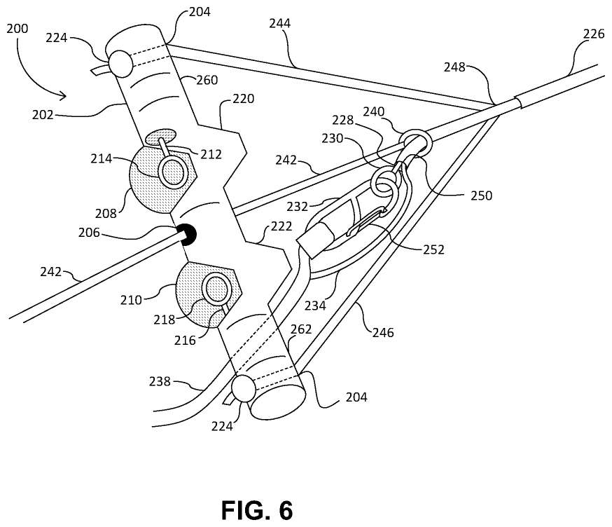

A transverse bore 122 is formed through the threaded portion of each end cap 116. The transverse bores 122 are located such that when the end caps are tightened onto the ends of the shaft 102, they align with the diametrically opposed holes 104 formed at each end of the shaft 102, thus creating an unobstructed passage through each end of the shaft 102 and the corresponding end cap 116. Such passages allow left and right tension lines, or lateral stabilizing lines to be threaded through the ends of the tow bar 100 and knotted off as shown, for example in FIG. 6. Similarly, a center tension line may also be threaded through the diametrically opposed holes 106 formed in the center of the shaft 102. Rather than being tied off in the manner of the left and right tension lines or left and right stabilizing lines, the center tension line is typically allowed to pass freely through the tow bar and is connected to a double hook arrangement mounted on a harness worn by the droneboarder or some other mechanism for securing the center tension line to the droneboarder.

Left and right thumb-control recesses 108, 109 are formed in the left and right ends of the shaft 102, respectively. The thumb-control recesses 108, 109 are oriented such that, when a droneboarder is gripping the tow bar 100 to be pulled forward by an unmanned aerial vehicle attached to the tow bar 100, the thumb-control recesses 108, 109 are generally facing the droneboarder in a manner such that the droneboarder's thumbs naturally fall into the thumb-control recesses 108, 109.

An opening 110 is formed in the outside surface 124 of the left thumb-control recess 108. A similar opening (not shown) is formed in the outside surface 125 of the right thumb-control recess 109. A multi-axis flight control input lever (joystick) 112 protrudes from the opening 110 into the left thumb-control recess 108. A thumb-ring 114 is formed on the end of the joystick 112. A similar joystick 113 having a thumb ring 115 extends into the right thumb-control recess 109. The joysticks 112, 113 with their associated thumb rings 114, 115 are oriented such that when a droneboarder is gripping the tow bar 100 as mentioned above, the droneboarder may easily slide his or her thumbs into the thumb rings 114, 115 to manipulate the positions of the joysticks 112, 113.

The joysticks 112, 113 are the input interfaces for a pair of dual-channel flight controllers housed within the hollow shaft 102. The dual-channel flight controllers generate flight-control signals for controlling the flight path of an unmanned aerial vehicle based on the positions of the joysticks 112, 113 and wirelessly transmit such signals to the unmanned aerial vehicle. The dual channel flight controllers may be configured, such that, for example, the left dual channel flight controller 112 generates a throttle control signal based on the position of the left joystick 112 along a first axis, and a yaw control signal based on the position of the left joystick 112 along a second axis. The right dual channel flight controller may generate a pitch control signal based on the position of the right joystick 113 along a third axis, and a roll control signal based on the position of the right joystick 113 along a fourth axis. Those skilled in the art will recognize that the joysticks 112, 113 with their associated thumb rings are but one form of multi-axis interface that may be employed on a droneboarding tow bar in accordance with the present invention. The joysticks 112, 113 could be replaced by, for example, an orthogonal array of arrowed push buttons (e.g. up-down, left-right) a thumb wheel, a track ball, a wireless inductive coil arrangement, or any other input device that would allow a droneboarder to conveniently and intuitively enter flight control commands for guiding an unmanned aerial vehicle using only his or her thumbs.

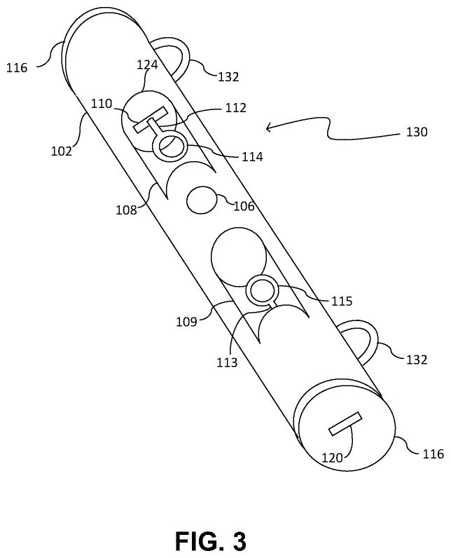

FIG. 3 shows an alternative embodiment of a droneboarding tow bar 130 having a thumb-operated flight control interface. The tow bar 130 is substantially identical to the tow bar 100 of FIG. 1. Identical structures in the tow bar 130 of FIG. 3 have been given the same reference numbers as shown in FIG. 1. On the tow bar 130 of FIG. 3, the diametrically opposed holes 104 formed at the left and right ends of the shaft 102, along with the transverse bores formed in the end caps 116, have been eliminated. Instead, eyelets 132 are attached to the outer surface of each end of the shaft. Separate left and right tension lines, or left and right stabilizing lines, as the case may be, may be tied directly to the eyelets 132 rather than being threaded through the ends of the shaft 102 and tied off with knots, as previously described.

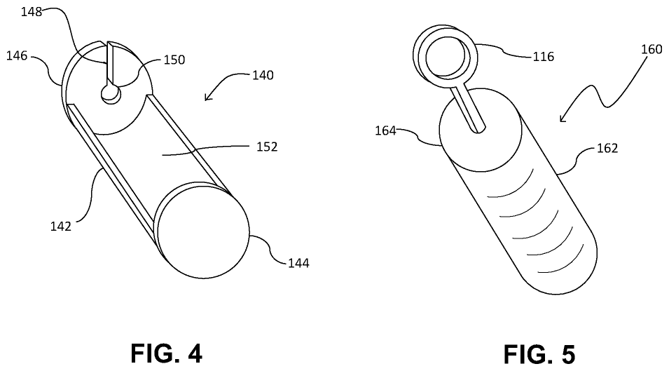

Turning now to FIGS. 4 and 5, a flight controller carrier or cartridge 140 and a dual-channel flight controller 160 are shown. The flight controller 160 includes a housing 162 and a joystick 164 having a thumb ring 166 integrally formed on the end thereof. The housing 162 houses the electronic circuitry for converting the mechanical position of the joystick 164 into flight control signals for controlling the flight path of an unmanned aerial vehicle, as wells the radio transmission circuitry for wirelessly transmitting the flight control signals to an unmanned aerial vehicle.

The carrier 140 is formed of a partial cylinder 142 and bottom and top end plates 144, 146, respectively. The partial cylinder 142 and the two end plates 144, 146 define a semi-cylindrical bay 152 for receiving the cylindrically shaped housing 162 of the dual channel flight controller 160. The top end plate 146 includes a radial slot 148 and a central aperture 150. The radial slot 148 allows the joystick 164 to pass through the top end plate 148 when the dual-channel flight controller 160 is inserted into the carrier 140. Once the dual-channel flight controller 160 is properly seated within the carrier 140, the joystick protrudes through the central aperture 150 of the top end plate 146 while the housing 162 rests securely in the semi-cylindrical bay 152.

A dual channel flight controller 160 secured within the semi-cylindrical bay 152 of the carrier 142 with the joystick 164 protruding through the center aperture 150 of the top endplate 146 forms an assembly that may be conveniently inserted into one end of the hollow shaft 102 comprising the tow bar 100. A second such assembly may be inserted into the opposite end of the hollow shaft 102. With the two carrier/flight controller assemblies 140/160 properly inserted into the hollow shaft 102, the end caps 116 may be rotated into place and tightened onto the ends of the shaft 102, thereby securing the assemblies within the shaft 102. In this arrangement the joysticks 164 and their associated thumb-rings extend into the left and right thumb control recesses 108, 109 as described with regard to FIG. 1.

Turning to FIG. 6, yet another embodiment of a droneboarding tow bar 200 is disclosed. Like the previously described embodiments, the tow bar 200 generally comprises a cylindrical shaft 202. Rather than a substantially straight shaft, however, the tow bar 200 includes two V-shaped offsets 220, 222. The left and right V-shaped offsets 220, 222 create corresponding left and right thumb control recesses 208, 210. They also define left and right handles 260, 262. As with the embodiments of FIGS. 1 and 3, left and right joysticks 212, 216 extend into the left and right thumb control recesses 208, 210, respectively. As with previous embodiments, the left and right joysticks 212, 216 terminate with thumb rings 214, 218. The location of the joysticks 212, 216 with their associated thumb rings within the thumb control recesses 208, 210 created by the V-shaped offsets 220, 222 allow a droneboarder to manipulate the joysticks 212, 214 with his or her thumbs while gripping the tow bar handles 260, 262.

FIG. 6 also shows a number of components associated with a typical droneboarding system. A tension line 228 connects the tow bar 200 as well as the droneboarder himself/herself to an unmanned aerial vehicle. The tension line 228 may include a sheath 226 that encloses both the tension line and an electrical cable 234. (The electrical cable 234 may be included to provide electrical power from a remote power supply worn by the user to the unmanned aerial vehicle.) The end of tension line 228 is attached to a metal ring 230 for attaching a safety leash 238 to the tension line 228. Lateral stabilizing lines 244, 246 are fastened to tension line at junction 248. The opposite ends of the lateral stabilizing lines 216, 218 pass through holes 204 formed in the ends of the tow bar 200 and are tied off with knots 224, as has been described in relation to the embodiment disclosed in FIG. 1. The tension line 228 passes through a second metal ring 240. A tension line extension 242 is fastened to the second metal ring 240. The tension line extension passes freely through a hole 206 formed through the center of the tow bar 200. The opposite end of the tension line extension 242 may be attached to a double hook mechanism on a harness worn by the droneboarder, or some other structure for securing the tension line to a droneboarder's body, as is known in the art. A first end of the safety leash 238 may be clipped to the harness worn by the droneboarder. Like the tension line 228, the safety leash 158 may include a sheath covering both the safety leash itself and a section of the electrical cable that provides remote power to the aerial vehicle. The second end of the safety leash 238 is fastened to a clip 232 with a spring-loaded latch 252. The clip 232 may be clipped onto the ring 230 to attach the safety leash 242 to the tension line 228.

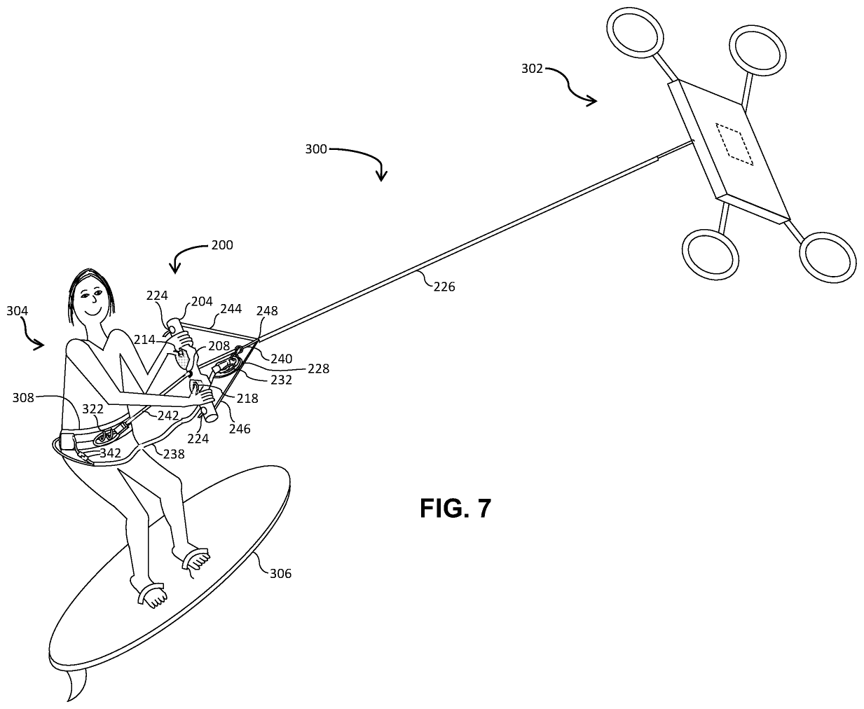

FIG. 7 shows droneboarding system 300 employing a tow bar according to the embodiment shown in FIG. 6. Again, like structures have been given identical reference numbers. A droneboarder 304 wearing a harness 308 rides a board 306. An unmanned aerial vehicle 302 is provided for pulling the droneboarder 304 over a surface, such as the surface of a lake, a river, the ocean, a snow-covered field, an asphalt or concrete aprion, or the like. A tension line 228 connects the unmanned aerial vehicle to the droneboarder 304.

The drone 302 is representative only. Features of the unmanned aerial vehicle 302, such as the configuration the unmanned aerial vehicle, the size and number of propellers, and such, will vary depending on the make and model of the unmanned aerial vehicle selected for the droneboarding system 300. All that is required of the unmanned aerial vehicle is that it be large enough and powerful enough to pull the droneboarder 304 and the board 306 on which the droneboarder is riding, over the particular surface the board is adapted to travel. For purposes of the present disclosure a generic four-propeller “quadcopter” is illustrated.

The board 306 may be a surfboard, a kiteboard, a wakeboard, a snowboard, one or more snow skis or water skis, a skateboard or longboard, or any other type of board on which an individual may ride over a surface, be the surface water, snow, asphalt, concrete or some other surface. Depending on the surface over which the droneboarder is being drawn, the board 306 may be replaced with some other means of conveyance, such as roller skates, inline skates, a bicycle, or the like.

The droneboarder 102 wearing the harness 308 holds a tow bar (in the example shown, the tow bar 200 according to the embodiment disclosed in FIG. 6). A tension line 228 is attached to the unmanned aerial vehicle 302. The opposite end of the tension line 228 passes through a metal ring 240 attached to a tension line extension 242 as has been described. The tension line extension 242 then passes through a hole 206 near the center of the tow bar 200 and attaches to a double hook mounted on the harness 308 via a quick release ring 324. Left and right lateral stabilizing lines 244, 246 are attached to the tension line at junction 248 located somewhere between the tow bar 200 and the unmanned aerial vehicle 302. The opposite ends of the left and right lateral stabilizing lines 244, 246 pass through the left and right ends of the tow bar 200 and are tied off with knots 224. As safety leash 238 is attached to the back of the harness 308 and is clipped to the metal ring 230 attached to the end of the tension line 228.

As shown in FIG. 7, the droneboarder grips the tow bar 200 with both hands, with his or her left hand gripping the handle 260 located to the left of V-shaped offset 220 and his or her right hand gripping the handle 262 to the right of the right V-shaped offset 222. With his or her hands in this position, the droneboarder's thumbs may conveniently engage the thumb rings at the ends of the joysticks 214, 218 as shown. By manipulating the joysticks with his or her thumbs, the user may control the flight path of the unmanned aerial vehicle 302.

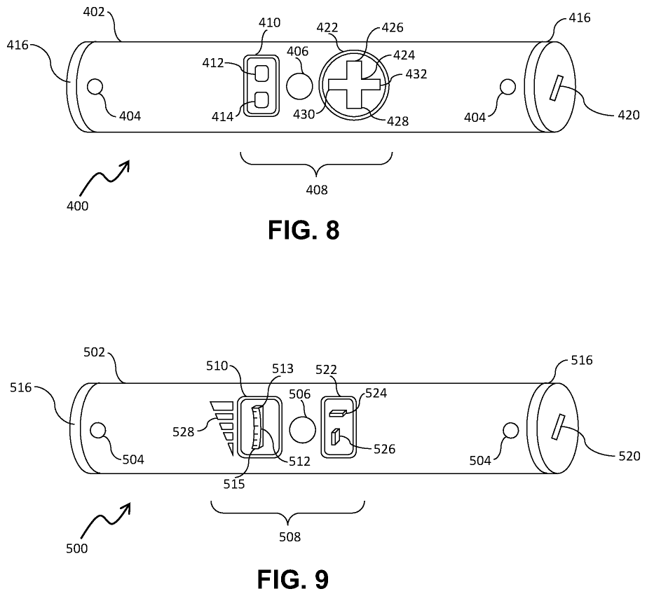

FIG. 8 shows an alternative embodiment of a droneboarding tow bar 400 having a thumb-operated flight control interface. Like previous embodiments, the tow bar 400 generally comprises a cylindrical shaft 402 that may be attached to a drone and that a droneboarder may hold onto to be pulled forward by the attached drone. Of course, the shape of the tow bar 400 need not be limited to a straight shaft. A wheel, handle, or some other shaped tow bar may be provided without deviating from the inventive concept of the present invention. Again, like the previous embodiments the tow bar 400 includes left and right tension line attachment holes 404 for attaching either separate left and right tension lines or left and right lateral stabilizing lines that attach to a center tension line. A central hole 406 is provided for allowing a center line to pass through tow bar 400 and attach to a harness worn by the droneboarder. A threaded end cap 416 with an indented slot 420 for tightening the end cap may be attached to each end of the tow bar 400 as has been described.

A thumb control interface 408 is provided on an outer surface of the shaft 402 located in a manner such that the interface may be manipulated by a droneboarder's thumbs when the droneboarder is gripping the tow bar 400. The thumb control interface comprises a throttle control input pad 410 and a pitch and roll control input pad 422.

The throttle control input pad 410 includes a throttle up button 412 and a throttle down button 414. Pressing the throttle up button 412 causes the controller housed within the tow bar 400 to send a wireless signal to the drone to increase the power delivered to the propellers driving the drone, causing the drone to ascend to a higher altitude. Pressing the throttle down button 414 causes the controller to send a wireless signal to the drone to decrease the power delivered to the propellers, causing the drone to descend to a lower altitude.

The pitch and roll input pad 422 includes a cruciform multi-input button 424. Pressing the upper arm 426 of the multi-input button 424 causes the controller to send a wireless signal to the drone instructing the drone to pitch forward, thereby increasing the forward thrust of the drone. Conversely, pressing the lower arm 428 of the multi-input button 424 causes the controller to send a wireless signal to the drone instructing the drone to pitch back, thereby decreasing the forward thrust of the drone. Pressing the left arm 430 of the multi-input button 424 causes the controller to send a wireless signal to the drone instructing the drone to pitch to the left. Conversely, pressing the right arm 432 of the multi-input button 424 causes the controller to send a wireless signal to the drone instructing the drone to pitch to the right.

FIG. 9 shows another alternative embodiment of a droneboarding tow bar 500 having a thumb-operated flight control interface. Like previous embodiments, the tow bar 500 generally comprises a cylindrical shaft 502 that may be attached to a drone and that a droneboarder may hold onto to be pulled forward by the attached drone. Of course, the shape of the tow bar 500 need not be limited to a straight shaft. A wheel, or a handle or some other shaped tow bar may be provided without deviating from the inventive concept of the invention. Again, like the previous embodiments, the tow bar 500 includes left and right tension line attachment holes 504 for attaching either separate left and right tension lines or left and right lateral stabilizing lines to the tow bar. A central hole 506 is provided for allowing a center line to pass through tow bar 500 and attach to a harness worn by the droneboarder. A threaded end cap 516 with an indented slot 520 for tightening the end cap may be attached to each end of the tow bar 500 as has been described.

A thumb control interface 508 is provided on an outer surface of the shaft 502 located in a manner such that the interface may be manipulated by a droneboarder's thumbs when the droneboarder is gripping the tow bar 500. The thumb control interface 508 comprises a throttle control input pad 510, a throttle gauge 528, and a pitch and roll control input pad 522.

The throttle control input pad 510 includes rocker-style switch 512 or alternatively, a sliding switch. Pressing the upper portion 513 of the rocker style switch 512 (or moving the slider upward in the case of a sliding switch) causes the controller housed within the tow bar 500 to send a wireless signal to the drone instructing the drone to increase the power delivered to the propellers driving the drone, thereby causing the drone to ascend to a higher altitude. Pressing lower portion 515 of the rocker style switch 512 (or moving the slider downward in the case of a sliding switch) causes the controller to send a wireless signal to the drone instructing the drone to decrease the power delivered to the propellers, thereby causing the drone to descend to a lower altitude. The throttle gauge 528 provides a visual indication of the current throttle level of the drone. In the embodiment shown in FIG. 9 the throttle gauge is formed of a series of LED lights, with the number of LEDs illuminated in the gauge 528 corresponding to the throttle level of the drone. Of course, other mechanisms for providing a visual indication of the throttle level may be substituted for the LED gauge 528 shown in FIG. 9.

The pitch and roll input pad 522 includes a lever-style pitch control input switch 524 and a lever-style roll control input switch 526. Pressing up on the lever-style pitch control input switch 524 causes the controller to send a wireless signal to the drone instructing the drone to pitch forward, thereby increasing the forward thrust of the drone. Conversely, pressing down on the lever-style pitch control input switch 524 causes the controller to send a wireless signal to the drone instructing the drone to pitch back, thereby decreasing the forward thrust of the drone. Similarly, pressing left on the lever-style roll control input switch 526 causes the controller to send a wireless signal to the drone instructing the drone to pitch to the left. Conversely, pressing right on the lever-style roll control input switch 526 causes the controller to send a wireless signal to the drone instructing the drone to pitch to the right.

Various embodiments of the invention have been described and illustrated. However, the description and illustrations are by way of example only. Other embodiments and implementations are possible within the scope of the invention and will be apparent to those of ordinary skill in the art. Therefore, the invention is not limited to the specific details of the representative embodiments, and illustrated examples in this description. Accordingly, the invention is not to be restricted except as necessitated by the accompanying claims and their equivalents.

1. A tow bar assembly adapted to be connected to an unmanned aerial vehicle via one or more tension lines for pulling a droneboarder, the tow bar comprising:
a substantially cylindrical hollow shaft having left and right ends;
left and right tension line attachment structures located near the left and right ends of the shaft, respectively;
a first multi-axis interface mounted to the shaft in a manner accessible to a droneboarder gripping the shaft, by which the droneboarder may enter flight control commands for controlling the flight path of the unmanned aerial vehicle;
electronic circuitry housed within the hollow shaft for interpreting the flight control commands received by the first multi-axis input device and generating a first set of flight control signals according to the received flight control commands; and
a first transmitter for wirelessly communicating the flight control signals to the unmanned aerial vehicle.

2. The tow bar of claim 1 wherein the shaft defines a first thumb-control recess and wherein the first multi-axis interface is accessible within the thumb control recess.

3. The tow bar of claim 2 wherein the first multi-axis interface device comprises a multi-axis input lever protruding into the first thumb-control recess.

4. The tow bar of claim 3 wherein the multi-axis input lever includes a thumb-ring mounted at a distal end of the multi-axis input lever, the thumb-ring being adapted to fit over the user's thumb such that the user may control the position of the multi-axis input lever via movements of the user's thumb.

5. The tow bar of claim 3 wherein the first multi-axis interface device, the electronic circuitry and the transmitter are included in a first self-contained drone-control package.

6. The tow bar of claim 5 further comprising a removable cartridge and a threaded end cap, wherein the cartridge is adapted to receive and securely hold the drone-control package, the drone-controller cartridge being insertable into the hollow shaft such that the multi-axis input lever extends into the thumb-control recess when the drone-control cartridge bearing the drone-controller package is inserted into the hollow shaft and wherein the threaded end cap may be rotatably secured to mating threads formed on an inner surface of the hollow shaft to secure the drone-control cartridge and the drone-control package within the hollow shaft.

7. The tow bar assembly of claim 5 further comprising a second thumb-control cavity, a second self-contained drone control package including a second multi-axis interface device, electronic circuitry for interpreting flight control commands received by the second multi-axes input device and a second transmitter for transmitting the second set of flight control signals to the unmanned aerial vehicle.

8. The tow bar assembly of claim 1, wherein the first multi-axis interface comprises a throttle control input device and a pitch and roll input device.

9. The tow bar assembly of claim 8 wherein the throttle control input device comprises a throttle up pushbutton and a throttle down pushbutton.

10. The tow bar assembly of claim 8 wherein the throttle control input device comprises a rocker-style switch.

11. The tow bar assembly of claim 8 wherein the throttle control input device comprises a sliding switch.

12. The tow bar assembly of claim 8 further comprising a throttle gauge that provides a visual indication of a throttle level to which the unmanned aerial vehicle is being commanded to operate.

13. A tow bar for use in a droneboarding system, the tow bar comprising:
a shaft adapted to be connected to an unmanned aerial vehicle via at least one tension line;
a multi-axis interface device associated with the shaft adapted to receive flight control commands from a user holding onto the shaft; and
a flight controller attached to the shaft adapted to generate flight control signals for controlling the flight path of the unmanned aerial vehicle according to the flight control commands received from the user via the multi-axis interface device and wirelessly transmit the flight control signals to the unmanned aerial vehicle.

14. The tow bar of claim 13 wherein the multi-axis input device comprises an orthogonal array of push buttons with a first pair of opposing push buttons representing a first control axis, and a second pair of opposing push buttons representing a second control axis.

15. The tow bar of claim 13 wherein the multi-axis input device comprises one of: a thumb-wheel; comprises a track ball; and a joystick.

16. The tow bar of claim 13 wherein the flight controller generates one of a throttle control signal; a yaw control signal; a pitch control signal; and a roll control signal, based on flight control commands received along a first axis of the multi-axis input device, and the flight controller generates another of a throttle control signal; a yaw control signal; a pitch control signal; and a roll control signal based on flight control commands received along a second axis of the multi-axis input device.

17. The tow bar of claim 13 further comprising a second multi-axis input device and a second flight controller, the first flight controller generating first and second flight control signals based on flight control commands received along first and second input axes of the first multi-axis input device, and the second flight controller generating third and fourth flight control signals based on flight control commands received along third and fourth input axes of the second multi-axis input device.

18. The tow bar of claim 13 wherein the shaft defines a first control recess and the multi-axis input device comprises a first control lever having a thumb-ring formed on a distal end thereof, and wherein the first control lever protrudes from within the shaft into the first thumb-control recess.

19. The tow bar of claim 20 wherein the shaft further defines a second thumb-control recess and wherein a second multi-axis input device comprises a second control lever having a thumb-ring formed on a distal end thereof, and the second control lever protrudes from within the shaft into the second thumb-control recess.

20. A remote-control radio interface device for controlling the flight path of an unmanned aerial vehicle, the remote control radio interface comprising:
a first multi-axis input device adapted to receive user flight commands;
a first multi-channel radio controller adapted to generate and transmit a plurality of flight control signals to an unmanned aerial vehicle, the flight control signals corresponding to the user commands received by the first multi-axis input device;
a first handle oriented such that a user grasping the handle with one hand may manipulate the first multi-axis input device with a thumb of that hand; and
a tension line securing means for securing a tension line to the remote-control radio interface device whereby an unmanned aerial vehicle attached to an opposite end of said tension line may pull the remote radio interface device, along with a user grasping the handle, forward in a direction the unmanned aerial vehicle is traveling.

21. The remote-control radio interface device of claim 20 wherein the first handle defines a first thumb-control recess and wherein the first multi-axis input device comprises a first multi-axis input lever that extends from the first handle into the first thumb-control recess.

22. The remote-control interface device of claim 21 wherein the first multi-channel radio controller is housed within the first handle.

23. The remote-control radio controller of claim 22 further comprising a second handle; a second multi-channel radio controller housed within the second handle; and a second multi-axis input device, the second handle defining a second thumb-control recess, and the second multi-axis input device comprising a second control lever that extends from the second handle into the second thumb-control recess.

24. The remote radio interface device of claim 23 wherein the first and second multi-axis-channel radio controllers generate a throttle control signal; a yaw control signal, a pitch control signal; and a roll control signal based on the position of the first input control lever along a first axis and a second axis, and the position of the second input control lever along a third axis and a fourth axis.

25. The remote control radio interface device of claim 20 wherein the first multi-axis input device comprises a cruciform multi-input pushbutton, wherein pressing an upper arm of the cruciform multi-input pushbutton corresponds to a pitch forward command; pressing a lower arm of the cruciform multi-input pushbutton corresponds to a pitch back command; pressing a left arm of the cruciform multi-input pushbutton corresponds to a roll left command; and pressing a right arm of the cruciform multi-input pushbutton corresponds to a roll right command.

26. The remote control radio interface device of claim 20 wherein the first multi-axis input device comprises a first horizontally oriented lever switch and a second vertically oriented lever switch, and wherein pressing the first lever switch upward corresponds to a pitch forward command; pressing the first lever switch downward corresponds to a pitch back command; pressing the second lever switch to the left corresponds to a pitch left command; and pressing the second lever switch to the right corresponds to a pitch right command.

27. The remote control radio interface device of claim 20 further comprising first and second throttle pushbutton inputs, wherein pressing the first throttle pushbutton input corresponds to a throttle up command and pressing the second throttle pushbutton input corresponds to a throttle down command.

28. The remote control radio interface device of claim 20 further comprising a visual throttle gauge indicating a throttle level to which the unmanned aerial vehicle is being commanded to operate.

29. The remote control radio interface device of claim 28 wherein the visual throttle gauge comprises a plurality of light emitting diodes arranged and illuminated in a manner to convey the throttle level to which the unmanned aerial vehicle is being commanded to operate.

30. A droneboarding system comprising:
an unmanned aerial vehicle;
a tow bar;
a tension line connected between the unmanned aerial vehicle and the tow bar;
an input device associated with the tow bar for receiving flight control commands from a droneboarder gripping the tow bar; and
a flight controller mounted within the tow bar adapted to generate flight control signals corresponding to the flight commands received by the input device and to wirelessly transmit the flight control signals to the unmanned aerial vehicle to control the flight path of the unmanned aerial vehicle.

31. The drone boarding system of claim 30 wherein the tow bar includes left and right line securing structures for securing one of left and right stabilizing lines and left and right tension lines.

32. The drone boarding system of claim 31 wherein the left and right securing structures comprise left and right holes formed through left and right ends of the tow bar so that the left and right stabilizing lines may be threaded through the left and right holes, respectively, and secured with knots. orthogonal

33. The drone boarding system of claim 31 wherein the left and right securing structures comprise left and right eyelets formed on an outer surface of the tow bar such that the one of left and right stabilizing lines and left and right tension lines may be tied directly to the eyelets.

34. The droneboarding system of claim 31 wherein the tow bar defines a first thumb-control recess.

35. The droneboarding system of claim 34 wherein the input device comprises a dual axis joystick that protrudes from the tow bar into the first thumb-control recess.

36. The droneboarding system of claim 34 wherein the input device comprises an orthogonal array of push buttons mounted on a surface of the tow bar.

37. The droneboarding system of claim 30 wherein the flight control signals generated by the flight controller comprise a throttle signal, a yaw signal, a pitch signal, and a roll signal.

38. The droneboarding system of claim 30 wherein the flight controller comprises a left flight controller and a right flight controller, and the input device comprises a left input device and a right input device, each input device oriented such that a droneboarder may manipulate the left input device using the drone boarder's left hand and the droneboarder may manipulate the right input device using the droneboarder's right hand while the droneboarder is gripping the tow bar with both hands, the left flight controller generating a first pair of flight control signals based on input commands received by the left input device, and the right flight controller generating a second pair of flight control signals based on input commands received by the right input device.
